(19) United States
(12) Patent Application Publication
(10) Pub. No.: US 2024/0319151 A1
(43) Pub. Date: Sep. 26, 2024

(54) CHROMATOSCOPY: AUTOMATED CHEMICAL ANALYSIS VIA IN-COLUMN SPECTROSCOPY

(71) Applicant: The Government of the United States of America, as represented by the Secretary of the Navy, Arlington, VA (US)

(72) Inventors: Tyler J. Huffman, Alexandria, VA (US); Robert Furstenberg, Burke, VA (US); Christopher Breshike, Spotsylvania, VA (US); R. Andrew McGill, Lorton, VA (US)

(21) Appl. No.: 18/125,781

(22) Filed: Mar. 24, 2023

(51) Int. Cl. G01N 30/74; G01N 30/72; G01N 30/78

(52) U.S. Cl. CPC G01N 30/74; G01N 30/722; G01N 30/78; G01N 2030/025; G01N 2030/746

(57) ABSTRACT

The present invention provides a method of chemically analyzing complex mixtures using spectroscopy and chromatography by collecting spectroscopy data at multiple points along a chromatography column to identify and quantify analytes in minutes. Also disclosed is the related system for chromatography and in-column spectroscopy for chemical mixtures and a larger microfluidic system incorporating the chromatography and in-column spectroscopy system.

### PRIORITY CLAIM

The present application is a non-provisional application claiming the benefit of U.S. Provisional Application No. 63/656,891, filed on Mar. 25, 2022 by Tyler J. Huffman et al., entitled “SIGNAL ENHANCEMENT METHODS FOR IN COLUMN INFRARED CHROMATOGRAPHY.” This application and all other publications and patent documents referred to throughout this nonprovisional application are incorporated herein by reference in their entirety.

### BACKGROUND OF THE INVENTION

### Field of the Invention

The invention relates to the field of chemical analysis of complex mixtures and combines techniques from spectroscopy and chromatography.

### Description of the Prior Art

Spectroscopy is a primary technique for the identification and quantification of pure materials. Spectroscopy can be understood as a generalization of color vision, where each pure chemical has a distinct collection of colors called a spectrum. However, in the same way that many different dye combinations will result in a black material, the spectra of chemical mixtures can be ambiguous. Thus, separation of the mixture into its components is generally necessary for high fidelity chemical analysis, especially when the sample is substantially unknown a priori. Such separation of mixtures is typically achieved via some chromatography technique. Indeed, the field of analytical chemistry is littered with hyphenated techniques that employ some spectroscopy or mass spectrometry technique after the chemistries involved are separated by, and ultimately elute from, a chromatographic column. We refer to this paradigm of chemical analysis as “end-column spectroscopy,” wherein chemical mixtures must first be separated into pure components by some chromatography technique before they are identified and quantified spectroscopically. At present, the best techniques for chemical analysis of mixtures fall into this paradigm.

Chromatography is a primary technique for separating mixtures. In the case of gas chromatography (GC), the GC column separates chemical components according to the thermodynamic properties of their interaction with a stationary phase medium, typically an adsorbent material, present along the length of the column. The separation process can be controlled or optimized by changing various operational parameters such as the column temperature, phase thickness, phase uniformity and carrier flow rate according to a procedure called a separation method. In conventional chromatography, a separation method must be decided upon a priori. Thus, the initial attempt at a separation method for an unknown mixture is always suboptimal and presents significant challenges for any field application, especially in the case where there is only one opportunity to perform the analysis. The preselection of a separation method for an unknown mixture is problematic since the separation process is highly sensitive to the operational parameters because of the exponential nature of the Boltzmann factor,

$$exp \frac{Δ G}{{k}_{B} T} ,$$

which characterizes the interaction between the analyte and the sorbent. It follows that a misspecification of the separation method will either result in an unsuccessful separation, or a separation that takes far longer than necessary.

In the laboratory, separation parameters are routinely optimized by an Analytical Chemist using a trial- and -error process called method development, which may take several days with no guarantee of success. In the field, lacking an expert Analytical Chemist, abundant sample, or the time necessary for method development, sensors must be tailored to a single specific application or suffer the exponential performance penalty associated with a suboptimal separation method. Despite significant effort to bring laboratory grade analytical techniques and instruments into the field, the inherent unsuitability of a fixed or static separation method for general chemical analysis means that the end-column paradigm will never be able to deliver rapid laboratory quality performance in the field.

Our previous work on in-column spectroscopy (U.S. patent application 20140260535A1 and U.S. patent application 20200355652A1) opened the door to a new paradigm of chemical analysis wherein the separation can be monitored in real time, inside and along the GC column, to allow for automatic tuning of the separation method and rapid acquisition of the spectral information (identity and quantity). Here we outline how in-column spectroscopy may be used to automate the process of chemical analysis for a completely unknown mixture and describe several technologies that improve upon the prior art.

### SUMMARY OF THE INVENTION

In the proposed “in-column” paradigm, a spectrum is collected at each point along the separation column resulting in a dataset, which we call a spectragram. From the spectragram, one can infer the spectrum and spatial distribution of each resolvable “peak” or “band”, which may be either a pure material or a yet unseparated subset of the mixture components. Collecting many spectragrams as a function of time, a “spectragram series”, allows for the characterization and real-time monitoring of separation dynamics. The new in-column paradigm proposed here does not require a separation scientist to develop the separation method. Instead, the method can be tuned in real time to enable high quality chemical analysis to be completed 100-1000 times faster—in seconds or minutes rather than hours or days. Moreover, in comparison to end column detection, this approach permits more rapid identification of threats via spectroscopic analysis before the analytes pass through the entire column. This is advantageous in detection applications because it allows one to choose a sorbent with a high affinity for an expected chemical threat(s). Such sorbents allow for trace detection by greatly concentrating the threat(s) relative to their presence in air or the carrier gas. However, the consequence of this approach is that the targeted threats may take a prohibitively long time to pass through the column, rendering end-column techniques unable to provide a timely warning of the threat. As a consequence, some separation methods are centered around the use of relatively nonpolar stationary phases, to avoid slow separations of polar unknown chemistries, when the separation method has been preset and cannot be cannot be adjusted on the fly to efficiently deal with slow eluters. FIG. 1 shows flow charts illustrating the end column and in column paradigms of chemical analysis.

Since this new approach is enabled by observing the separation process as it occurs, we call this technique chromatoscopy—literally “viewing the color/separation/spectra (inside and along the chromatography column).” While any number of “chromatoscopies”—combinations of chromatography and spectroscopy techniques—are possible, here we focus on the case of gas chromatography and infrared spectroscopy, “GC-IR Chromatoscopy”. We note that the technique presented here would be trivially transferred to the case of gas chromatography and Raman spectroscopy “GC-Raman Chromatoscopy” by choosing a prism material that is transparent at the relevant wavelengths, and making some appropriate modifications to the source and detection schemes. Other chromatoscopies will be apparent to those skilled in the art of the various spectroscopic and chromatographic techniques.

An overview of the system is presented in FIG. 2.

As in conventional GC, a gas, the “mobile phase”, flowing at some velocity Um is passed over a sorbent, the “stationary phase”. The fraction of time each analyte molecule spends embedded in the stationary phase depends on the partition ratio, K(T), which arises from the analyte's interaction with the sorbent. Consequently, for analytes with different interactions with the stationary phase, each analyte peak or band traverses the column at a different velocity vₚₑₐₖ(T)=vₘK(T). Since the primary operational parameter in GC is typically the temperature T, we explicitly show the temperature dependence of the partition ratio K(T) and the peak velocity vₚₑₐₖ.

Chromatoscopy differs from conventional GC because we can optically observe each analyte as it makes its way through the column. Optical access is provided by an infrared transparent prism, included as part of the GC column. The strength of the infrared signal can be increased by (i) increasing the number of “bounces” within the prism, which increases the effective interaction length of the infrared light with the sorbent/analytes, and by (ii) embedding metallic nanostructures within the sorbent on the surface of the prism. The latter technique of using a metallic nano-structure to enhance infrared absorption is known as Surface Enhanced InfraRed Absorption Spectroscopy (SEIRAS), and is closely related to the more common technique of Surface Enhanced Raman Scattering (SERS).

Separation is normally controlled with a single global column temperature that changes as a function of time. However, with chromatoscopy, the ability to observe the separation in real time invites one to additionally control the column temperature as a function of position with multiple heating elements in an array along the column. While this would be far too many parameters for a human to manage, modern data science can be employed to develop a control algorithm that will allow much faster separation of the slowest moving peaks, resulting in much faster detections and identifications than would be possible without spatial column temperature control. One simple but effective control scheme is to heat each peak or band individually such that each observed peak exits the column (or passes some other arbitrary point) fully resolved (separated by 2σ) in some targeted measurement time. This gives each observed peak, which may or may not be a pure (separated) analyte, the best chance of separating further in the measurement time, on a finite length column, L, using that stationary phase.

Chromatoscopy need not be a stand-alone technique. We envision the core chromatoscopy device as the key component in a microfluidic system, a so-called “lab on a chip”, that would be capable of analyzing an unknown mixture more thoroughly than a single chromatoscopy device alone. An illustrative schematic overview of two example systems is shown in FIGS. 3A and 3B.

The first system consists of a single chromatography column and the associated optical components, which we call a “chromatoscopy core.” In the first system, we explicitly show a potential implementation of the optics wherein optical fibers are used to direct the infrared light to the various probe locations along the column and to collect the light for detection. Micropumps and valves are used to guide and re-route the analytes through the systems based on the real-time data being collected. The layout is such that peaks can be cycled through the column multiple times to provide additional column length for challenging separations and higher signal to noise through increased measurement time. Once chromatoscopic analysis is complete, the separated analytes can be sent to one of many possible end-column spectrometer/detector based on the chromatoscopic analysis.

The second example contains 4 chromatoscopy cores, Each chromatoscopy core is coated with a different sorbent so that the sorbent chemistry (or chemistries) that are most effective for separation of any particular sample can be employed. It is not necessary to employ every possible sorbent. Instead, four or so distinct chromatoscopy cores, each coated with an appropriate sorbent emphasizing a different solubility property (e.g. hydrogen-bonding basicity, hydrogen bonding acidity, diploarity, and apolarity), should practically cover the full space of solvation parameters and permit quite general chemical analysis. After the chromatoscopic analysis on each chromatoscopy core is complete, the analytes can be optionally directed to the appropriate end-column spectrometer/detector for further identification/quantification. While it would be possible to use free space optics in either design, the fiber based approach is particularly powerful with multiple cores because it frees the system from various optical constraints and allows better size, weight, and power consumption (SWAP). Note that we have suppressed the visibility of the fibers, infrared source, and detector in the four core example for clarity.

### Definitions

A spectrum is a signal that can be measured or composed along a continuous variable, such as energy in optical spectroscopy, or mass-to-charge ratio in mass spectrometry.

A spectragram is a dataset where a spectrum is measured at various spatial points, or at different times, or both.

Spectroscopy is the experimental technique wherein spectra are collected or analyzed. The spectrum of a material is a distinguishing feature that is used to identify materials like a fingerprint. The spectrum can be used to quantify a material by comparing its spectrum to the spectra that results from measuring a known quantity of material.

Spectral de-mixing is a method for analyzing a spectragram to extract the distinct spectral components and their relative contributions at each measured spatial or time coordinate in the spectragram. The canonical example of spectral de-mixing is colloquially referred to as the “Cocktail Party Problem” in which the task is to identify the words spoken by several individuals as a party based on the data recorded by several microphones placed around the room. Several standard methods exist such as Principal Component Analysis (PCA), Independent Component Analysis (ICA) and Non-negative Matrix Factorization (NMF). Generally, the goal of spectral de-mixing is to extract two matrices, the spectral matrix-which tabulates the distinct spectra- and the mixing matrix-which tabulates the relative contribution of each spectra at the spatial or temporal locations measured in the spectragram.

Non-Negative Matrix Factorization (NMF) is a method of spectral de-mixing wherein the values of the spectral matrix and the values of the mixing matrix are assumed to be positive.

The mobile phase is a flowing material into which the components of a chemical mixture dissolve in chromatography.

The stationary phase is a fixed material into which the components of a chemical mixture dissolve in chromatography.

Chromatography is any laboratory technique for the separation of a mixture into is components wherein the mixture is carried in a mobile phase which flows over/through some stationary phase which interacts with the mixture components. The components of the mixture are separated based on the relative affinity of each chemical in the mixture for the stationary and mobile phases.

### BRIEF DESCRIPTION OF THE DRAWINGS

FIG. 1 shows flow charts illustrating the two paradigms of chemical analysis.

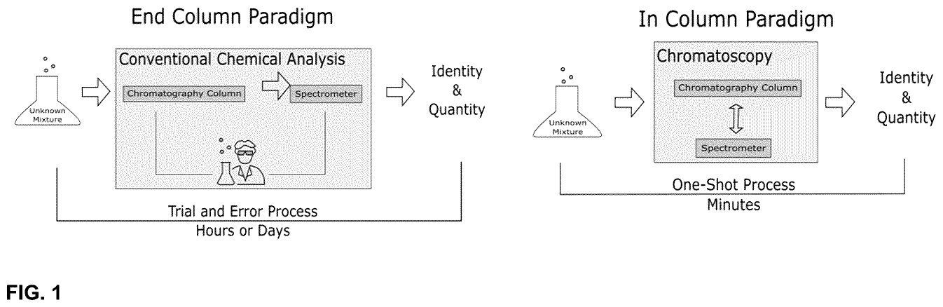

FIG. 2 is a schematic overview of the chromatoscopy technique.

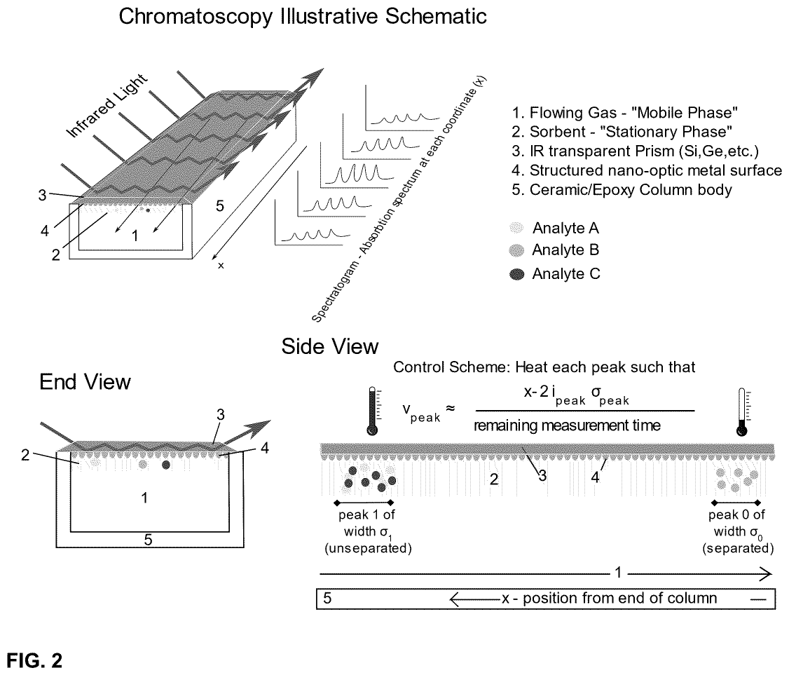

FIGS. 3A and 3B are schematics of two example microfluidic systems incorporating chromatoscopy. FIG. 3A shows a one core system. FIG. 3B shows a four core system.

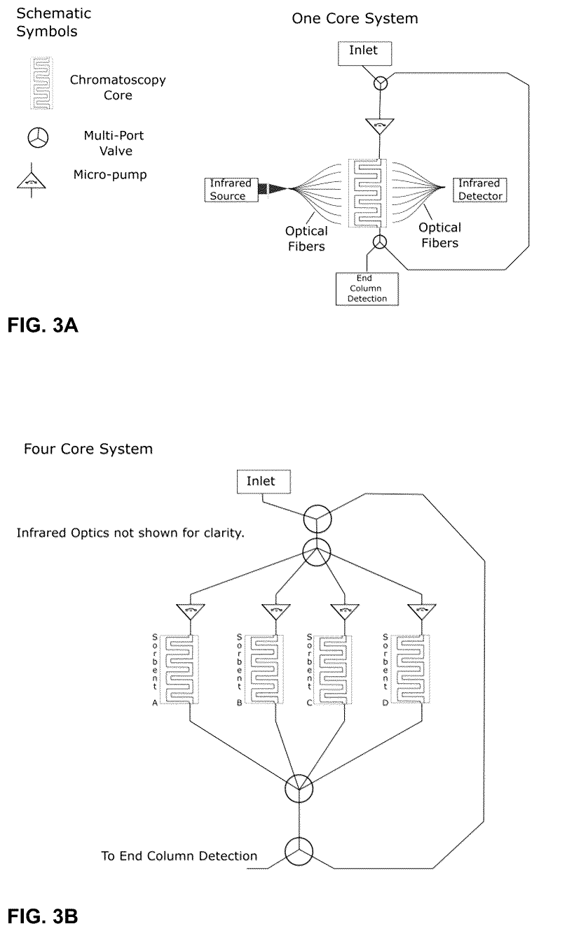

FIG. 4 is a sketch of a preferred prism geometry showing a prism with an index of refraction of 4 and a chamfer angle θ of 39 degrees.

FIG. 5 is a graph showing the enhancement factor ϵ provided by embedding some fraction of gold in the common sorbent PolyDiMethylSiloxane (PDMS).

FIG. 6 shows the absorption spectrum of PDMS (top) and a spectrum showing the maximum ϵB product that can be employed with PDMS before the signal to noise is compromised by absorptive losses in the sorbent (PDMS).

FIG. 7 is a schematic of the variable sorbent gain method of signal enhancement.

FIG. 8 is a demonstration of Monte Carlo NMF analysis of a spectragram.

FIG. 9 is a demonstration of Monte-Carlo/Bayesian NMF analysis and order selection (inferring the number of analytes) from the spectragram using the Bayesian Information Criteria (BIC). Note that the correct order (3) has the lowest BIC and the median fit (solid lines) is closest to the ground truth (dashed lines). The shaded region shows the 1%-98% inter-quantile range.

FIG. 10 shows a structure for resistive heating, thermometry, and infrared signal enhancement via SEIRAS.

FIG. 11 is a schematic of chromatography friendly microfluidic components and a schematic stackup of how the flow can be routed through a chromatography friendly microfluidic system. The flow routing (bottom) connects the micropump and valve shown at the top of the figure.

FIG. 12 shows the effect of a pump on a chromatography peak.

### DETAILED DESCRIPTION OF THE INVENTION

Broadly speaking, the present invention is to use in-column spectroscopy to automate the process of chemical separation. In this section, we describe several enabling technologies in more detail. Broadly speaking, these technologies fall into the following categories:
Signal enhancement—Our previous work on in-column spectroscopy does provide a sensitivity comparable with the end column detectors commonly used in the laboratory today. We present both optical methods of signal enhancement, and methods that exploit the properties of the sorbent to improve sensitivity.
Data Analysis—The data must be analyzed to infer actionable information about the state of the analyte mixture separation, namely the spectra of the analytes and how the analytes are distributed in the column, what separation scientists call a peak. We also describe how further “hierarchical” analysis yields additional useful information.
Automation and Temperature Control—Armed with the spectra and the peaks corresponding to each analyte (or some as yet unseparated mixture of two or more analytes), we present an approach to automate the separation process. We also present a method to control and measure the temperature as a function of position along the column.
Microfluidic System—Unfortunately, traditional microfluidic components are not chromatography friendly because of either the presence of dead volume which degrades the quality of the separation or the use of materials, particularly plastics, that are not chemically inert. Thus, we describe a zero dead volume valve, a chromatography friendly micropump, and a method of chip construction/flow routing that is appropriate for a chromatoscopy based microfluidic system.

### Signal Enhancement

### Optical Signal Enhancement

Our earlier work on in-column GCIR spectroscopy used an infrared (IR) transparent prism to enable optical access through a single bounce attenuated total reflection (ATR) prism. This is convenient because it only requires one side of the column to be infrared transparent (although two IR transparent prisms could be positioned opposite each other and both operated in a similar fashion). However, we find that the signal produced for a single interaction of the infrared beam with the sorbent/analyte mixture to be too low to image low concentrations of analyte within the column. Moreover, extremely thin sorbents, which yield lower IR signals than thick sorbents, are preferred to limit slow diffusion processes and achieve the most effective separation. Thus, the spectroscopic and chromatographic goals compete in the single bounce ATR embodiment.

We employ the following optical techniques to enhance the signal:

### Multi-Bounce ATR

Multiple optical bounces can be used to increase the effective interaction length between the infrared light and the sorbent/analyte mixture, while still allowing for the thin sorbent phases preferred for chromatography. The system geometry can be configured so that the bounces occur along the column (along the direction of carrier gas flow) or across the column (perpendicular to the direction of carrier gas flow). When the bounces occur along the column, the signal enhancement comes at the cost of spatial resolution in the spectragram. When the bounces occur across the column, the channel may need to be widened to accommodate multiple bounces, which can lead to compromised separation through increased diffusion of the analytes. Ultimately, the choice of multi-bounce geometry depends on the application. Our preferred multibounce prism has a chamfer angle θ that depends on the prism material's index of refraction (n) according to the following transcendental equation:

$$θ = \frac{90 ° - arcsin ( \frac{sin ( 90 ° - θ ) )}{n}}{2}$$

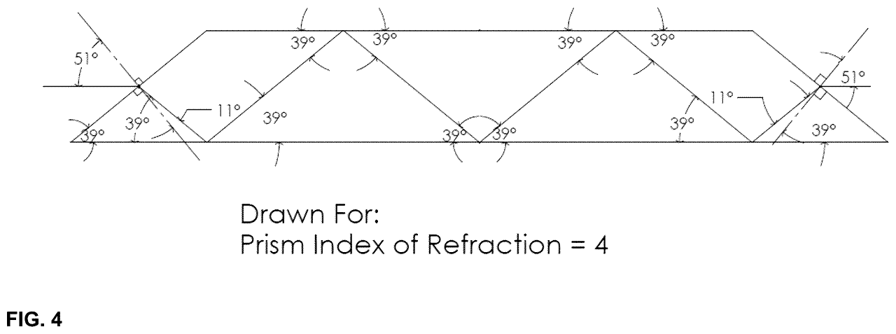

A sketch of such a prism for the case where n=4 is shown in FIG. 4, for the simplified case of 3 bounces for clarity. This preferred geometry keeps the light within the plane of the device, simplifying alignment and allowing for a more compact device. Furthermore, the large angle of incidence approaches the Brewster angle, allowing p-polarized light to enter (and exit) the prism with minimal losses to reflection. When a polarized infrared source such as a laser is available, this will mitigate or eliminate the need for an anti-reflective coating on the high refractive index prism. Note that all internal reflections are larger than the critical angle (14.5° for the n=4 case).

Another useful prism geometry is for the light to be incident normal to the surface of the prism to eliminate refraction at the first interface. The geometry of such a prism can then be tuned to increase the number of bounces per unit length (when the chamfer angle is small) without inducing internal reflections that exceed the critical angle.

### Surface-Enhanced InfraRed Absorption Spectroscopy (SEIRAS)

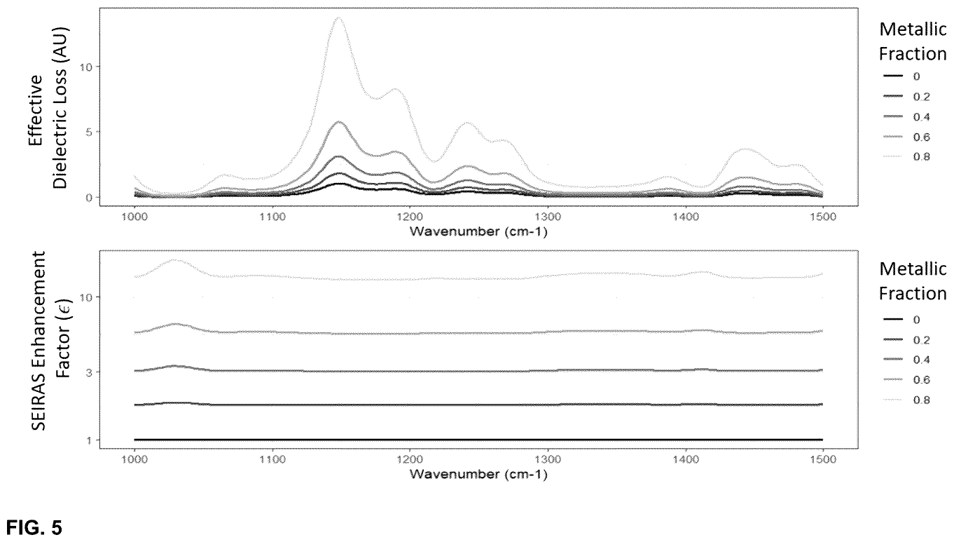

Metallic nano-structures can be embedded within the sorbent to enhance the strength of the interaction between the infrared light and the sorbent/analyte mixture. While there are several ways to understand why this is the case, the end result is that the effective infrared cross section is greatly enhanced. For low resonant structures such as metallic spheres, the enhancement can be an order of magnitude or more. Additional enhancement is possible with highly resonant structures, but the enhanced signal comes at the cost of spectral bandwidth. The preferred nanostructures are designed to be weakly resonant to achieve maximum signal enhancement whilst still maintaining an acceptably flat spectral response over the spectral range of interest. Using the Maxwell-Garnet theory for effective media, an estimate of the enhancement [increase in the absorption coefficient k (or equivalently the IR cross section σ)] provided by SIERAS is shown in FIG. 5 for the case of gold nanostructures in PolyDiMethylSiloxane (PDMS), a common stationary phase sorbent. This effect considers isolated, nonresonant structures, and thus constitutes a lower limit for the enhancement factor provided by SEIRAS.

Now we consider the effect of these methods on the sensitivity of the system. We use the signal to noise ratio (SNR) of the absorption spectrum as the figure of merit for sensitivity. For shot-noise limited detection, which will essentially always be the case in laser spectroscopy, the SNR is given below:

$$SNR = \frac{{ϕ}_{Absorbed} Δ t}{\sqrt{{ϕ}_{Transmitted} Δ t}} = \sqrt{{ϕ}_{0} Δ t} [ 1 - exp [ - {n}_{a} ϵ {σ}_{a} {Bt}_{s} ] ] exp [ \frac{{n}_{a} ϵ {σ}_{a} {Bt}_{s}}{2} ] exp [ \frac{{n}_{s} ϵ {σ}_{s} {Bt}_{s}}{2} ]$$

### Where:

ϕ*0:* incident infrared photon flux
ϕ Absorbed:photon flux Absorbed by the Analyte
ϕ_{Transmitted}: photon flux passing through the device to the detector, i.e. not absorbed by the analyte or sorbent.
Δt:measurement time
nₐ:number density of analyte
nₛ:number density of sorbent
ϵ:SEIRAS enhancement factor
B:Number of bounces
tₛ:sorbent thickness
σₐ: analyte infrared cross-section

In the trace analyte limit (nₐ→0), where sensitivity is of primary concern, the SNR reduces to:

$$\begin{matrix}SNR \approx \sqrt{{ϕ}_{0} Δ t} [ {n}_{a} ϵ {σ}_{a} {Bt}_{s} ] [ 1 - \frac{{n}_{a} ϵ {σ}_{a} {Bt}_{s}}{2} ] exp [ - \frac{{n}_{s} ϵ {σ}_{s} {Bt}_{s}}{2} ] \\ SNR {\to }^{Neglecting doubly small terms} \sqrt{{ϕ}_{0} Δ t} {n}_{a} ϵ {σ}_{a} {Bt}_{s} exp [ - \frac{{n}_{s} ϵ {σ}_{s} {Bt}_{s}}{2} ]\end{matrix}$$

We can maximize the SNR, and thus the sensitivity, when the product of the number of bounces and the SEIRAS factor (ϵB) is as shown:

$$SNR is maximized when \frac{\partial SNR}{\partial ϵ B} = 0 \to ϵ B = \frac{2}{{n}_{s} {σ}_{s} {t}_{s}} = \frac{2}{α {t}_{s}} = \frac{1}{2 π {kvt}_{s}}$$

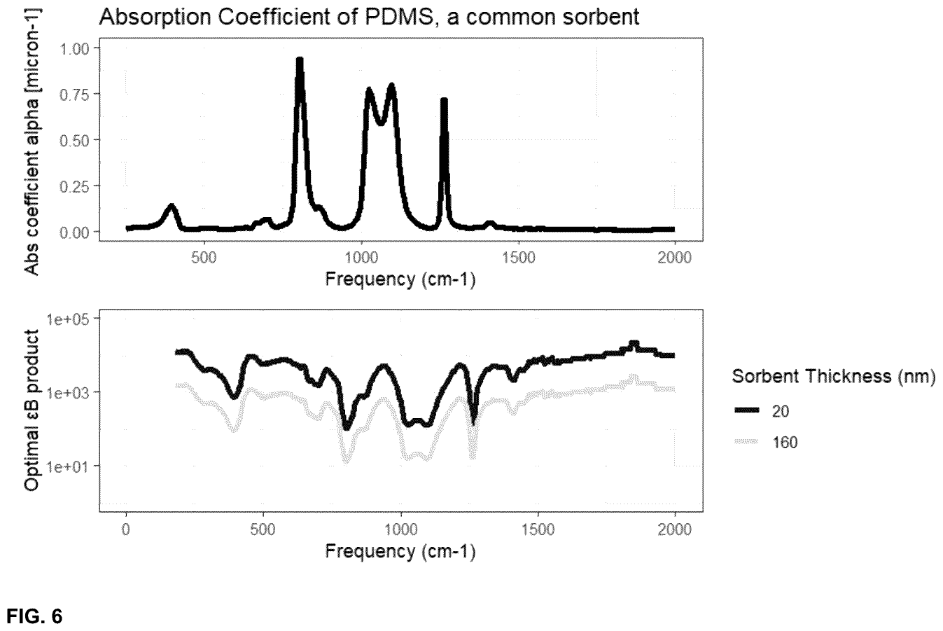

To get a sense of reasonable values, we visualize the optimal ϵB product for the common sorbent PDMS for 2 cases of the sorbent thickness, tₛ=160 nm and tₛ=20 nm, (See FIG. 6).

We note that even for fairly thick sorbents, the optimal ϵB product is fairly large, on the order of 1000 or greater in regions of the spectrum that do not have infrared modes. To achieve such a large factor with either of these techniques alone would require an impractical number of bounces or highly resonant SEIRAS, which would likely compromise spectral bandwidth unacceptably. Thus, for best performance, it is preferable to use both methods together. It turns out that using both techniques together is straightforward: The thin prism required for multi-bounce ATR can be produced by cutting and polishing the prism chamfers on a standard infrared transparent wafer-preferably silicon or germanium. Such a wafer is the preferred substrate for depositing/lithographing/patterning nanostructures.

### Sorbent-Kinetic Signal Enhancement

Within the column, the sorbent has the effect of concentrating the analytes from the gas phase. That is to say, the sorbent itself leads to a signal enhancement when probed optically. The concentration increase (relative to the gas phase) is equal to the analyte partition ratio in the sorbent at a particular temperature. The simplest way to make use of this effect is to choose a sorbent with a high partition ratio, and thus a high affinity, for the analytes of interest. This serves to concentrate the analyte within the sorbent relative to the gas phase.

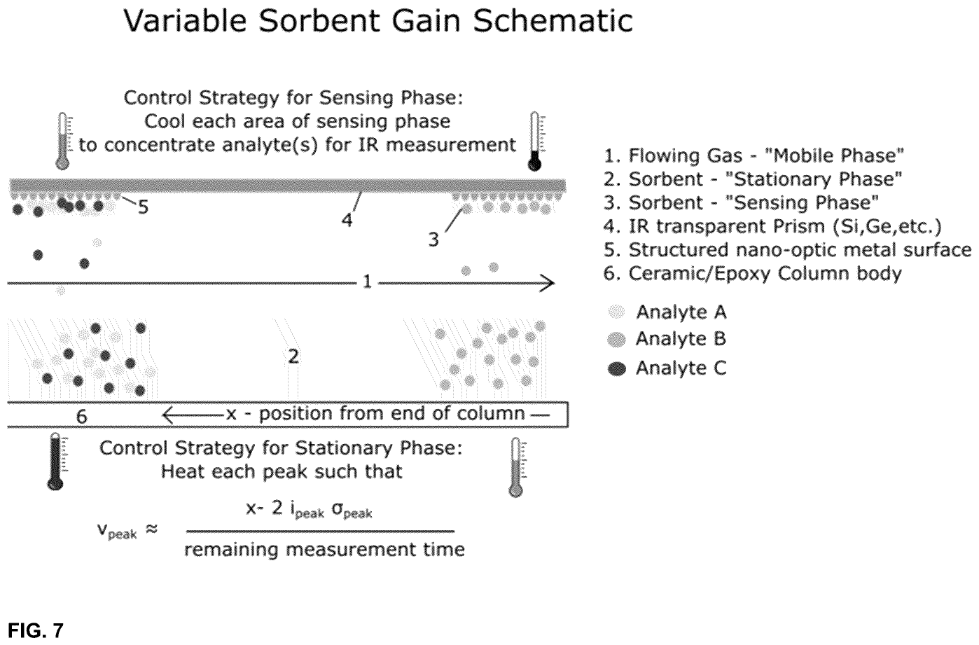

Another useful approach is to introduce a third sorbent phase, the “sensing phase” which may be held at a lower temperature than the conventional stationary phase. The result of this (relative) cooling is to dramatically increase the concentration of the analyte in the sensing phase, where it will be measured, relative to the stationary phase. It would be ideal if this approach did not appreciably alter the analyte peak (or band) dynamics, so that the temperature of the stationary phase can be used to control the separation, and the temperature of the sensing phase can be used to provide an effective type of variable gain to concentrate the analytes to near saturation in the sensing sorbent. A schematic overview of this approach is presented in FIG. 7.

That the “sensing” sorbent layer does not appreciably alter peak dynamics holds provided the following two conditions are met:
1.) A similar fraction of total analyte molecules reside in the mobile phase to mitigate any change to the peak velocity. This situation can be realized given the partitioning sketched in FIG. 7: while most of the analyte molecules are dissolved in the stationary phase sorbent, as usual, some (small) fraction is concentrated in the thin sensing phase sorbent. Thus, we estimate the upper limit of practical sorbent gain to be the case when the number of analyte molecules in the stationary phase N_{stationary} is roughly equal to the number of analyte molecules in the sensing phase N_{sensing}. For sorbent films of thickness d, the maximum practical sorbent gain

$$Γ = \frac{{c}_{sensing}}{{c}_{stationary}} ,$$

where C denotes the concentration of analyte in either phase, is roughly:

$$\frac{{N}_{sensing}}{{N}_{stationary}} > \frac{{d}_{sensing} exp [ - \frac{{E}_{b}}{{k}_{b} {T}_{sensing}} ]}{{d}_{stationary} exp [ - \frac{{E}_{b}}{{k}_{b} {T}_{stationary}} ]} \to {Γ}_{max} = \frac{exp [ - \frac{{E}_{b}}{{k}_{b} {T}_{sensing}} ]}{exp [ - \frac{{E}_{b}}{{k}_{b} {T}_{stationary}} ]}$$

Where E_{b} is the binding energy between the analyte molecule and the sorbent, T is the temperature and N denotes the number of adsorbed analytes in either sorbent. We note that Γ can be quite dramatic, given the exponential nature of the Boltzman factors and the high binding energies that can be achieved with targeted sorbents.
2.) The time for analytes to diffuse through the stationary phase sorbent of thickness d should be the limiting (slowest) time constant τ of the system. This ensures that the introduction of the sensing phase does not delay the system from achieving thermodynamic equilibrium. Otherwise, analytes would “stick” in the sensing phase sorbent after the bulk of the analyte peak has eluted further down the column. Assuming the diffusion constant

$$D ∝ \frac{{d}^{2}}{τ}$$

is proportional to T, as predicted by the Stokes-Einstein equation,

$$τ ∝ \frac{{d}^{2}}{T} .$$

### Thus,

$${τ}_{sense} \leq {τ}_{stationary} \to \frac{{T}_{sense}}{{T}_{stationary}} \leq \frac{{d}_{sense}^{2}}{{d}_{stationary}^{2}}$$

This relation places a limit on how much the sensing phase can be cooled relative to the stationary phase. More extreme relative cooling is possible when the sensing phase sorbent is thin.

Thus, both conditions imply that a thin sensing phase sorbent is advantageous for this approach. We note the high synergy between this technique, which requires a very thin sensing phase sorbent, and the optical signal enhancement techniques discussed previously which permit a strong infrared signal to be collected despite such a thin sorbent.

### Data Analysis

### Top Level Data Analysis

Unfortunately, the raw spectragram is quite difficult for a human to interpret. Thus, the critical element for analysis of chromatoscopy data is to split the spectragram back into its chromatographic and spectroscopic halves, revealing the distributions of each analyte at different points along the column—the chromatography half- and the corresponding spectra of each analyte—the spectroscopy half. This can be achieved through the various algorithmic methods of handling the “Cocktail Party Problem”, which is concerned with factoring matrices like so:

$${\underbrace{{D}_{xv}}}_{Data Matrix Spectragram} = {\underbrace{{M}_{xp}}}_{Mixing Matrix Chromatography Half} {\underbrace{{S}_{pv}}}_{Spectral Matrix Spectroscopy Half}$$

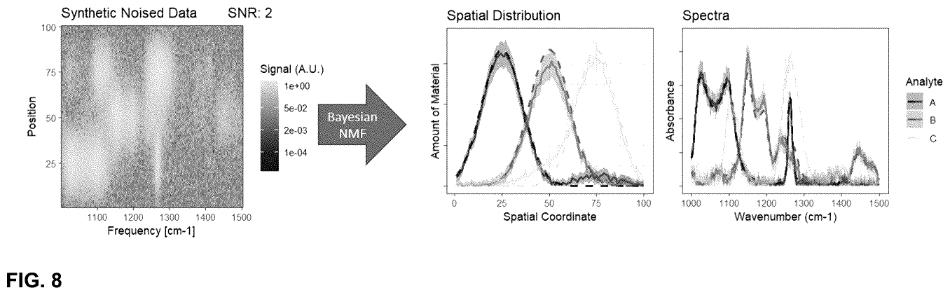

Of the many solutions to the “cocktail party” problems, which include familiar methods such as principal component analysis (PCA) and independent component analysis (ICA), the one that makes the most appropriate assumptions for absorption spectroscopy is Non-negative matrix factorization (NMF) in that it reasonably assumes that all elements should be positive, and does not make any assumptions that would force the inferred spectra or chromatograms to be orthogonal, which they do not need to be. A demonstration of the Monte-Carlo version of NMF on noised data is shown in FIG. 8. The Monte-Carlo/Bayesian approaches are preferred because they quantify the uncertainty of the inferred parameters. It's worth noting that even though the SNR in the example shown in FIG. 8 is quite low, the effective SNR of the infrared spectra and chromatograms is much higher. This is a testament to the power of taking a large amount of data, and analyzing it with a statistical model that is consistent with the underlying physical reality.

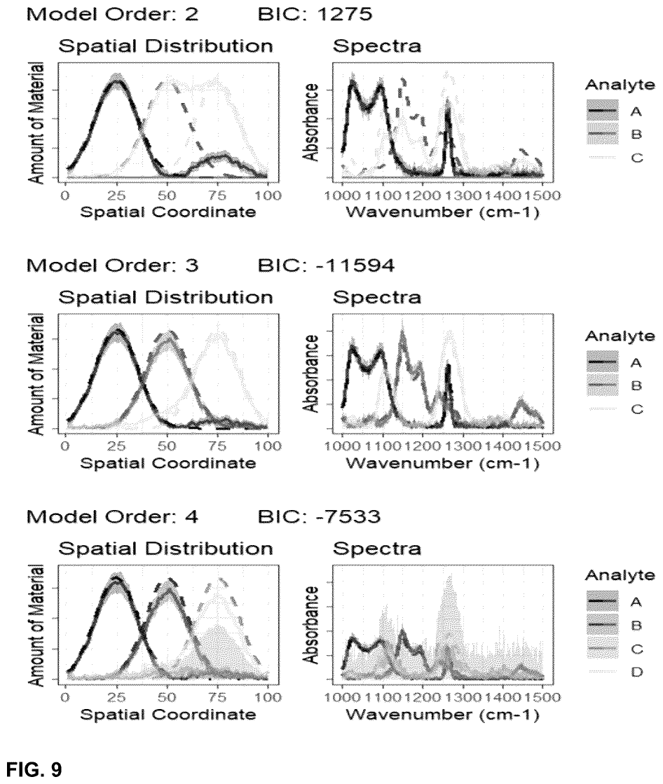

One subtlety of the matrix factorization is that the number of analytes (the “p” [peak] index in the above equation), which is known as the “order” of the matrix factorization, is not known a priori. Instead, it must somehow be inferred from the spectragram. Failure to use the correct order tends to give nonphysical and absurd results. Inferring the correct order falls under a field of data science known as model comparison. In our tests so far, we've seen that simple heuristic forms of model comparison, such as choosing the order that results in the best Bayesian Information Criterion (BIC) works well. If need be, more exact approaches to model comparison such as “bridge sampling” are possible. The heuristic approaches are highly preferred because more exact approaches can be extremely computationally expensive. An example of model comparison with synthetic data is shown in FIG. 9.

### Hierarchical Data Analysis

Once the data has been split into spectroscopic and chromatographic halves, it is natural to perform further analysis, what statisticians would call a hierarchical model, to extract information of interest from either field. Potential examples of such further analysis are discussed below:

### Spectroscopic Analysis

The most natural use of the infrared spectra is to compare them to a standard library of analytes. This would be useful for identification. Quantification can also be performed in this way if the infrared library is quantitative, i.e. the infrared library has meaningful y-axis units such as imaginary index k, absorption coefficient α or infrared cross section σ_{IR}.

The spectra may also be decomposed into chemical functional groups. This is particularly useful in detection applications because it would permit the system to alert on novel chemical analyte threats that are not already in the library provided they contain functional groups that are known to be present in harmful chemicals.

### Chromatographic Analysis

Further analysis of the chromatographic data (the mixing matrix) is necessary for automating the separation. Given a time series of spectragram data, it should be clear how one might infer the velocity of each peak. Of particular interest is the velocity of each peak as a function of temperature. The velocity of each peak v(T) is of primary interest to the automation of the separation process, and its use will be discussed further in the automation section. However, there is interesting information to be inferred that resides one level further down in the hierarchical analysis.

$$v ( T ) = {\underbrace{{v}_{m}}}_{\text{"} Mobile Phase Velocity} {\underbrace{K ( T )}}_{Partition Ratio} = {v}_{m} exp [ Aa ( T ) + Bb ( T ) + Ee ( T ) + Ss ( T ) + c ( T ) ] )$$

One can approximate the temperature dependent partition ratio using a parameterization of the sort shown above in a parameterized solvation equation, reminiscent of the Michael Abraham solvation parameterization. The lowercase letters (e,s,a,b,l,c) are the solvation parameters for the sorbent (solvent phase), while the uppercase parameters (A, B, E,S) characterize the analyte (solute). For our purposes, it is useful to force the solvation parameters of the analyte to be temperature independent by construction, as shown above. This is a reasonable simplification to make because each of the products in the sum characterize a distinct interaction that will have its own temperature/energy scale that should depend more on the fundamental physics of the interaction than the chemical details of the analyte. Since the sorbent is the same for all analyses with a given device, these values and their temperature dependence can be well characterized a priori. Moreover, the temperature independent analyte parameters can serve as a useful secondary “fingerprint” for each analyte that can be used to supplement the spectrum, the primary fingerprint, for identification process. Thus, this method could be used to distinguish isomers that have identical infrared spectra, but vary in how they interact with the sorbent. For example, this sort of secondary fingerprint could be used to distinguish between different alkanes that will have very similar infrared spectra.

### Automation

### Controlling the Separation

Consider a signal peak or band corresponding to an unseparated mixture within a column. Our task is to choose the temperature that will give this peak the best chance to separate into its components in the finite length of the column L and some finite tolerable measurement time t. It turns out that for the best chance of separating a peak in finite length, keeping the location of the peak or band as cold as possible, within the tolerance of elution velocity time, is advantageous. This is because the sorbent solvation parameters mentioned in “Chromatographic Analysis” above are larger at lower temperatures, leading to more marked differences in the degree of analyte interactions with the sorbent stationary phase. However, for the best chance of separating a peak in a limited finite time, one should heat the peak or band as much as possible. However, in the usual case where both column length L and measurement time t are important, if the temperature we choose is too low, none of the components will measurably or sensibly move forward in the column, and the components will not separate in an acceptable time. If the temperature is too high, the mixture components will move together in the carrier gas through the column such that they do not separate before they exit the finite length column. Thus, the proper temperature for our one unseparated peak is simply the one that makes it move at a velocity of approximately

$${v}_{peak} \approx \frac{L}{t} .$$

It turns out that this strategy is suitable for any resolved peak we observe within the column, because there is no way to tell a priori if the peak is separated or not.

Some modification is in order when there is more than one observable peak or band within the column (i.e. our order selection algorithm indicates that the number of analytes is greater than one). In this case, the target velocities of the peaks should be altered in such a way that they will be clearly resolved at the end of the experiment. For example, the slower peaks can be slowed so that each peak ends up clearly resolved, i.e. separated by several multiples of the peak width σₚₑₐₖ.

### Temperature Control

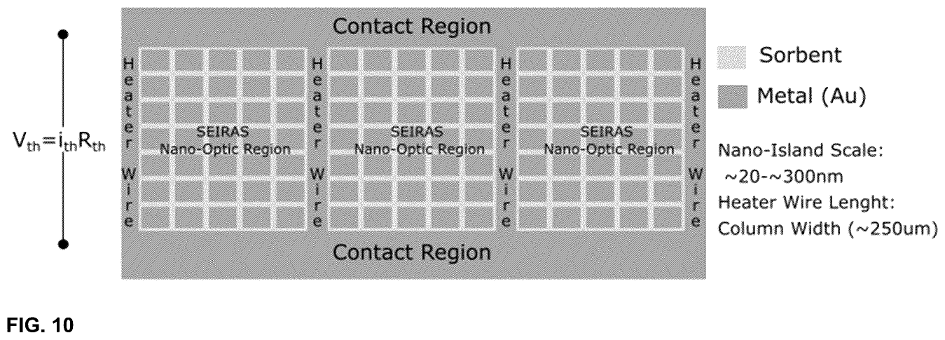

In the traditional process of chromatography method development, the primary control variable is a single global temperature at any particular time for the entire column. However, given the above discussion, it would be desirable to control the velocity of each peak individually. To this end, we need a way to control the temperature as a function of position along the column. Thus, we propose the structure shown in FIG. 10 be placed on the prism surface:

This structure accomplishes the goals of signal enhancement (through the SERIAS regions) and temperature control through resistive heating. While only four heater traces/wires are shown for clarity, many more such traces can be used to ensure even heating over the structure. Nonuniformity in the temperature of the sorbent would degrade the quality of the separation. By monitoring both the current and voltage across each structure, the heater wires can be used not only as the heating element, but also as a resistive thermometer to close the temperature control loop. To simplify the fabrication process, it is desirable to etch/lithograph the metallic features from the same gold layer.

### Chromatoscopy in Complex Microfluidic Analytical Systems.

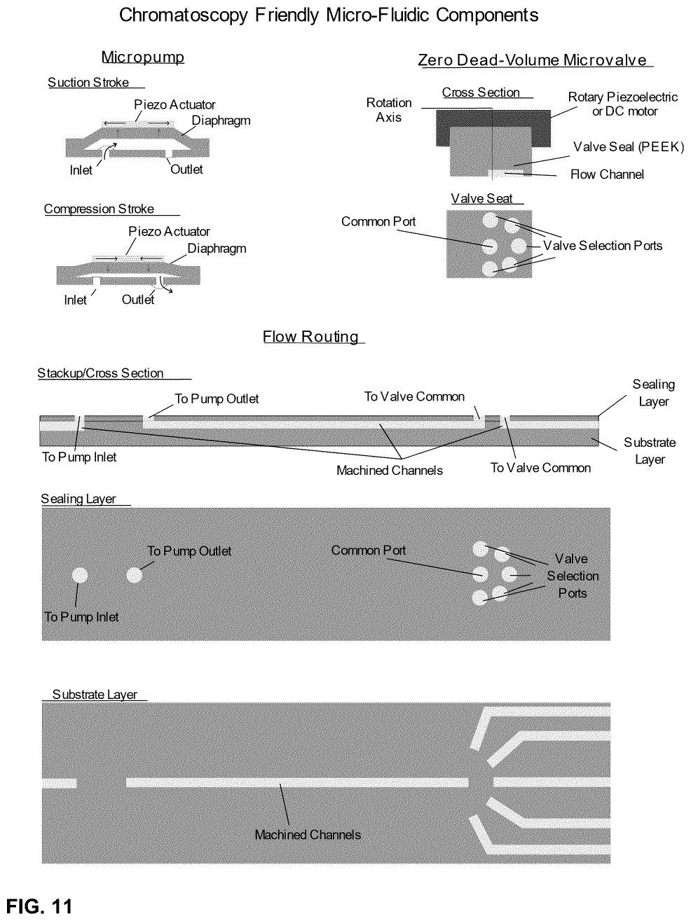

To be compatible with chromatoscopy, all components of a microfluidic system should be able to withstand relatively high temperatures (˜200° C.) and all materials in contact with the analytes should be chemically inert to avoid undesirable adsorption/reaction. Preferable materials are stainless steel, ceramic, or polyetheretherketone (PEEK). This material pallet provides a metal and an insulator that will enable electrical isolation/connection and an inert plastic, which can be used for dynamic seals. For static seals, stainless steel and ceramic can be braised and have matched thermal expansion coefficients, minimizing the strains induced when the assembly is heated. To route gas flow between components, the channels can be precision machined into stainless steel, and then sealed with a second layer welded (preferably via laser welding) to the first. In some cases, one may machine the channels through a stainless steel sheet, and then weld appropriate sealing layers to the top and bottom. This construction is similar in function to a PCB in electronics, in that it significantly reduces the size, fragility, and complexity of the final assembly (see FIG. 11). Static seals between this board and individual components can be achieved via welding or brazing as appropriate.

Micro-pumps and multi-port valves permit the construction of very flexible analysis systems. Presently, we describe a zero dead volume valve, a chromatography friendly micropump that is appropriate for chromatoscopy based microfluidic systems. Further discussion of the various components follows below. Schematics of each are shown in FIG. 11.

### Multi-Port Valves

Eliminating dead volume is a common design goal in chromatography systems, since dead volume can cause tailing of the peaks. The usual valves used in chromatography are large, stand-alone devices that are not well suited for integration into chip-based designs. Meanwhile, while microfluidic valves are designed to minimize dead volume, eliminating it entirely is generally not required in these applications.

### Micro-Pump

The traditional micropump design involves a layered structure, passive valves, and is driven by a piezoelectric actuator.

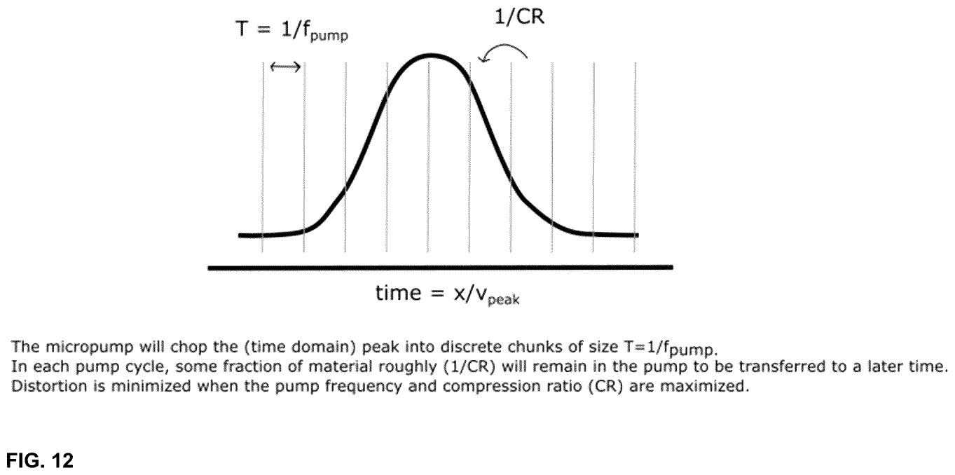

The effect of the micropump on the peaks is shown in FIG. 12. To minimize the perturbations, one should design the micropump to minimize the cycle time T (maximize the operating frequency fₚᵤₘₚ) and maximize the compression ratio

$$CR = \frac{Δ V}{{V}_{0}} ,$$

where ΔV is the change in volume of the pump chamber over a cycle, and V₀ is the minimum volume of the pump chamber. The effect of the micropump is to discretize the (time domain) peak into chunks of size

$$T = \frac{1}{{f}_{pump}} .$$

After each cycle, some fraction of the material will remain in the pump chamber and get transferred into the next time slice. Micropumps of the sort shown in FIG. 11 can be designed to have Compression ratios approaching 90% and operating frequencies greater than 100 Hz. For a typical chromatography peak with a characteristic width of around a second, the perturbation induced in each pass through the pump is negligible.

The above descriptions are those of the preferred embodiments of the invention. Various modifications and variations are possible in light of the above teachings without departing from the spirit and broader aspects of the invention. It is therefore to be understood that the claimed invention may be practiced otherwise than as specifically described. Any references to claim elements in the singular, for example, using the articles “a,” “an,” “the,” or “said,” is not to be construed as limiting the element to the singular.

1. A method of automated analysis of chemical mixtures, comprising
introducing an unknown mixture to a chromatography column;
collecting spectroscopic data to observe and characterize the separation of the unknown mixture within and along the chromatography column, and
tuning operational parameters of the chromatography column in real time to optimize the separation in an automated fashion.

2. The method of claim 1, wherein temperature is controlled as a function of spatial position along the chromatography column via one or more microscale resistive heating elements.

3. The method of claim 2, wherein the resistance across the one or more heating elements is monitored to measure temperature and provide feedback control to ensure that a targeted temperature is achieved.

4. The method of claim 2, wherein one or more sensing phase sorbents are maintained at a lower temperature than a stationary phase to concentrate the analyte molecules in a sensing phase to better present analyte molecules to a spectrometer.

5. The method of claim 4, wherein temperature of the one or more sensing phase sorbents is actively controlled to dynamically control the concentration of analytes.

6. The method of claim 1, wherein infrared or Raman spectroscopy is used to inform control of gas phase chromatographic separation.

7. The method of claim 6, wherein a spectroscopic signal is enhanced via a multi-bounce attenuated total reflection prism.

8. The method of claim 7, wherein a chamfer angle, θ, of the multi-bounce attenuated total reflection prism is set using the transcendental equation
$$θ = \frac{90 ° - arcsin ( \frac{sin ( 90 ° - θ ) )}{n}}{2} .$$

9. The method of claim 6, wherein metallic nanostructures are used to enhance the signal.

10. A method of data processing for the analysis of chemical mixtures, comprising
introducing a mixture comprising analytes to a chromatography column;
collecting a spectrum at multiple points along the chromatography column to form a spectragram, and
splitting the spectragram into a chromatographic part comprising a mixing matrix and a spectroscopic part comprising a spectral matrix.

11. The method of claim 10, wherein the spectragram is split using Non-Negative Matrix Factorization.

12. The method of claim 10, wherein the uncertainty is quantified using a Bayesian approach.

13. The method of claim 10, wherein a method of order selection such as the Bayesian Information Criterion or Bridge Sampling is used to determine the number of analytes from the spectragram.

14. The method of claim 10, wherein the mixing matrix is further analyzed to determine solvation parameters.

15. The method of claim 14, wherein Abraham solvation parameters are used to identify analytes, to automate chromatography column temperature, or both.

16. The method of claim 14, wherein solvation parameters of a sorbent are temperature dependent and solvation parameters of the analyte are temperature independent.

17. The method of claim 14, wherein solvation parameters are used to identify analytes.

18. The method of claim 12, wherein the spectral matrix is further analyzed for analyte identification, quantification, or both.

19. The method of claim 12, additionally comprising analyzing the spectral matrix to detect the presence of chemical functional groups.

20. A system for chromatography and in-column spectroscopy for chemical mixtures, comprising:
one or more infrared light sources;
one or more chromatography columns, each comprising a column body, an infrared transparent prism, a flowing gas mobile phase, one or more sorbents, and multiple probe points along the column body;
an input fiber bundle to direct infrared light from the one or more infrared light sources to the multiple probe points;
one or more infrared light detectors;
an output fiber bundle to send light from the multiple probe points to the one or more infrared light detectors; and
temperature control for the one or more sorbents.

21. The system of claim 20, wherein the one or more infrared light source is a tunable laser.

22. The system of claim 20, wherein the one or more infrared detectors is a linear array.

23. The system of claim 20, wherein the one or more infrared detectors is a 2D imaging spectrometer.

24. The system of claim 20, wherein the column body comprises a machinable ceramic.

25. The system of claim 20, wherein the temperature control for the one or more sorbents uses resistive heating and thermometry to minimize the number of required electrical contacts.

26. A microfluidic system comprising the system of claim 20.
